(19) United States
(12) Patent Application Publication
(10) Pub. No.: US 2016/0232471 A1
(43) Pub. Date: Aug. 11, 2016

(54) SYSTEMS AND METHODS TO COMPARE DEALER SERVICE RETENTION

(71) Applicant: GM GLOBAL TECHNOLOGY OPERATIONS LLC, DETROIT, MI (US)

(72) Inventors: ROBERT R. INMAN, ROCHESTER HILLS, MI (US); MICHAEL S. HARBAUGH, CLARKSTON, MI (US)

(73) Assignee: GM GLOBAL TECHNOLOGY OPERATIONS LLC

(21) Appl. No.: 14/618,351

(22) Filed: Feb. 10, 2015

(51) Int. Cl. G06Q 10/06; G06Q 50/00

(52) U.S. Cl. CPC G06Q 10/06393; G06Q 50/00

(57) ABSTRACT

The present technology relates to systems and methods for measuring, benchmarking, and improving dealer service retention effectiveness using a pairwise dealer comparison on shared customers.

### TECHNICAL FIELD

The present disclosure relates generally to dealer service retention.

### BACKGROUND

Dealer service retention is generally a metric that measures the performance of a service department of a vehicle dealer. Dealer service retention measures, for example, of a number of vehicles in operation, the number of vehicles that visit a dealer for repair or maintenance. Dealer service metrics and benchmarks are often biased and provide unfair measures that are not accepted by the dealer network. For example, some metrics can make good performers look bad and poor performers appear good. In addition, very little actionable information is provided to dealers who want to improve service performance.

### SUMMARY

The present technology relates to measuring, benchmarking, and improving dealer service retention effectiveness using a pairwise dealer comparison based on shared customers.

Methods comparing dealers using a pairwise comparison facilitate analyzing and improving dealer service retention. Improved dealer service retention improves the revenue and profit from parts for both the dealer and the original equipment manufacturer. Indirectly, increased dealer service retention improves new vehicle sales because there is a positive relationship between dealer service retention and repeat vehicle sales.

Other aspects of the present technology will be in part apparent and in part pointed out hereinafter.

### DESCRIPTION OF THE DRAWINGS

FIG. 1 illustrates schematically a system including a computing unit, according to an embodiment of the present disclosure.

FIG. 2 illustrates a method for measuring, benchmarking, and generating improvement guidance to improve dealer service retention, according to an embodiment of the present disclosure.

FIG. 3 illustrates schematically a first dealer in a first area and neighboring dealers in neighboring areas.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

As required, detailed embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern.

While the present technology is described primarily herein in connection with automobile dealers that service automobiles, the technology is not limited to automobile dealers. The concepts can be used in a wide variety of applications, such as in connection with aircraft, marine craft, non-vehicle products, and other.

The present disclosure describes systems and methods that include 1) a metric of actual service retention that facilitates a pairwise comparison of dealers and 2) an object to enable dealers to take effective improvement actions. The object can be used to identify improvement opportunities for individual dealers.

As described herein, the term “service retention” refers to a measure (e.g., observed or estimated using a model) of how many of the vehicles within a category are serviced by a dealer. Exemplary categories are based on whether a vehicle (i.e., represented by a vehicle identification number (VIN)) is within an area associated with a dealer and whether the dealer sold the vehicle.

As described in further detail below, actual service retention is calculated based on collected data (e.g., the service retention of a dealer that is observed within a category).

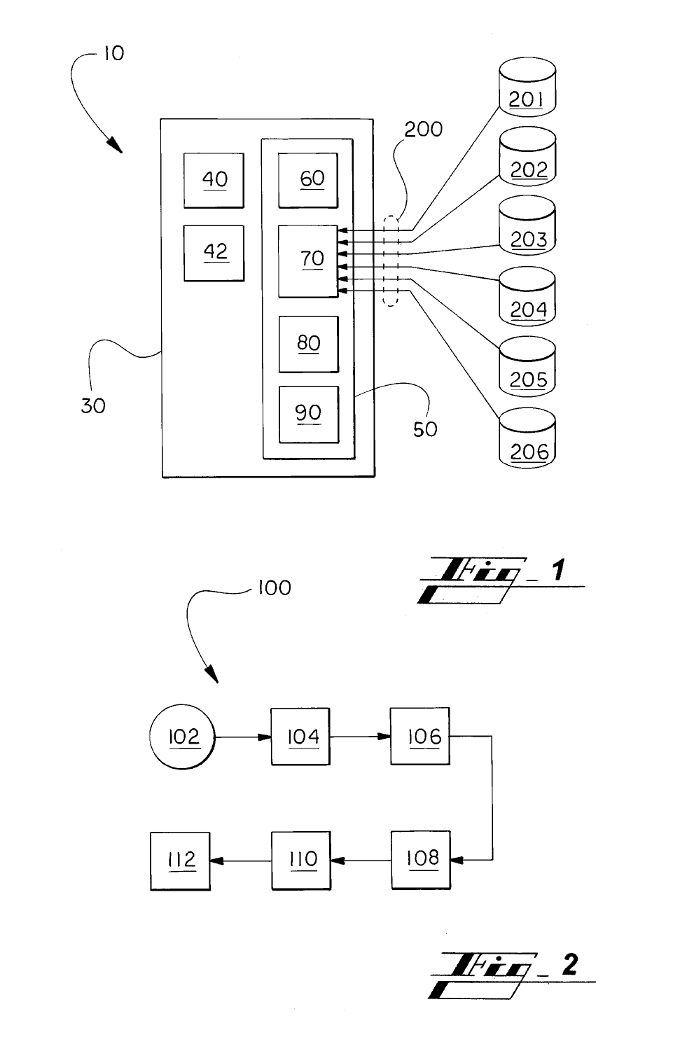

### FIG. 1

### System and Computing Structure

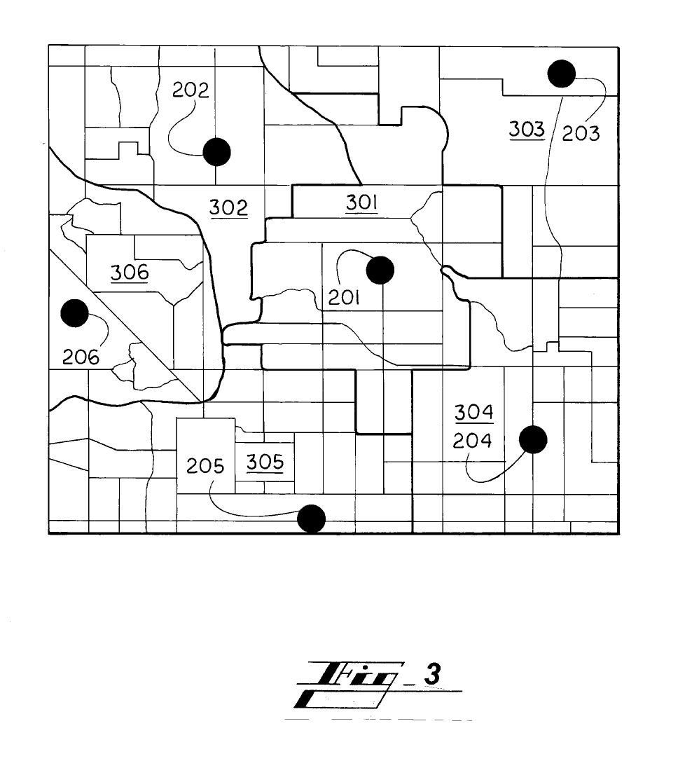

According to one embodiment, a system 10 is configured to perform a method 100 illustrated in FIG. 2. FIG. 1 shows features of the system 10 schematically. The system 10 includes a computing unit 30. The computing unit 30 includes a processor 40 for controlling and/or processing data, input/output data ports 42, and a memory 50. Connecting infrastructure within the system 10, such as one or more data buses and wireless transceivers, are not shown in detail to simplify the figures.

The processor could be multiple processors, which could include distributed processors or parallel processors in a single machine or multiple machines. The processor could include virtual processor(s). The processor could include a state machine, application specific integrated circuit (ASIC), programmable gate array (PGA) including a Field PGA, or state machine. When a processor executes instructions to perform “operations,” this could include the processor performing the operations directly and/or facilitating, directing, or cooperating with another device or component to perform the operations.

The memory 50 can include a variety of computer-readable media, including volatile media, non-volatile media, removable media, and non-removable media. The term “computer-readable media” and variants thereof, as used in the specification and claims, includes storage media. Storage media includes volatile and/or non-volatile, removable and/or non-removable media, such as, for example, RAM, ROM, EEPROM, flash memory or other memory technology, CDROM, DVD, or other optical disk storage, magnetic tape, magnetic disk storage, or other magnetic storage devices or any other medium that is configured to be used to store information that can be accessed by the computing unit 30.

While the memory 50 is illustrated as residing proximate the processor 40, it should be understood that at least a portion of the memory can be a remotely accessed storage system, for example, a server on a communication network, a remote hard disk drive, a removable storage medium, combinations thereof, and the like. Thus, any of the data, applications, and/or software described below can be stored within the memory and/or accessed via network connections to other data processing systems (not shown) that may include a local area network (LAN), a metropolitan area network (MAN), or a wide area network (WAN), for example.

The memory 50 includes several categories of software and data used in the computing unit 30 including applications 60, a database 70, an operating system 80, and input/output device drivers 90.

As will be appreciated by those skilled in the art, the operating system 80 may be any operating system for use with a data processing system. The input/output device drivers 90 may include various routines accessed through the operating system 80 by the applications to communicate with devices, and certain memory components. The applications 60 can be stored in the memory 50 and/or in a firmware (not shown) as executable instructions, and can be executed by the processor 40.

The applications 60 include various programs that, when executed by the processor 40, implement the various features of the computing unit 30. The applications 60 include applications described in further detail with respect to exemplary methods. The applications 60 are stored in the memory 50 and are configured to be executed by the processor 40.

The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

The applications 60 may use data stored in the database 70. The database 70 includes static and/or dynamic data used by the applications 60, the operating system 80, the input/output device drivers 90 and other software programs that may reside in the memory 50.

It should be understood that FIG. 1 and the description above are intended to provide a brief, general description of a suitable environment in which the various aspects of some embodiments of the present disclosure can be implemented. While the description refers to computer-readable instructions, embodiments of the present disclosure also can be implemented in combination with other program modules and/or as a combination of hardware and software in addition to, or instead of, computer readable instructions.

### FIG. 2

### Method of Operation

FIG. 2 shows an exemplary method 100 that facilitates analyzing and improving service retention, according to an embodiment of the present disclosure. It should be understood that the steps of the method 100 are not necessarily presented in any particular order and that performance of some or all the steps in an alternative order is possible and is contemplated. The steps have been presented in the demonstrated order for ease of description and illustration. Steps can be added, omitted and/or performed simultaneously without departing from the scope of the appended claims.

It should also be understood that the illustrated method 100 can be ended at any time. In certain embodiments, some or all steps of this process, and/or substantially equivalent steps are performed by execution of computer-readable instructions stored or included on a computer readable medium, such as the memory 50 of the computing unit 30 described above, for example.

The method 100 begins 102 and flow proceeds to blocks 104, 106, 108, 110, 112. Blocks 104, 106, 108, 110 are associated with computer-executable instructions for a method of generating an improved metric of actual service retention; and block 112 is associated with computer-executable instructions for generating a pairwise comparison object with actionable feedback to enable dealers to take more effective improvement actions.

In block 104, the processor 40 accesses dealer service data 200 stored in the memory 50. The dealer service data 200 includes data that represents vehicles (e.g., same-brand vehicles), the dealer (or dealers) that have serviced the vehicle, and the location of the customer who owns the vehicle. For example, referring momentarily to FIG. 1, the dealer service data 200 is entered at individual dealerships into databases by dealers 201, 202, 203, 204, 205, 206 when a service is performed and is accessed from the dealer databases or aggregated and accessed from database 70.

In block 106, the dealer service data 200 is sorted or filtered into different categories or sets. One or more cells of Table 1 represent a category, as described in further detail below. The variables in Table 1 represent a number of vehicles in different sets, as described in further detail below.

TABLE 1

| | Sold | Not Sold |
|---|---|---|
| In Area | a | b |
| | A | B |
| Out of Area | c | d |
| | C | D |

In Table 1, variable a is the number of vehicles that were sold (or leased) by a dealer of interest (hereinafter interest dealer) to customers residing in the interest dealer's area and that were serviced by the interest dealer; variable b is the number of vehicles that were sold by a comparison dealer to customers residing in the interest dealer's area and that were serviced by the interest dealer; variable c is the number of vehicles that were sold by the interest dealer to customers residing out of the interest dealer's area and that were serviced by the interest dealer; and variable d is the number of vehicles that were sold by a comparison dealer to customers residing out of the interest dealer's area and that were serviced by the interest dealer.

In certain embodiments, a service by a dealer is counted in the number of vehicles serviced by the dealer only if the service is within a certain time frame or window. For example, the time window is the first year of ownership, years two to six of ownership, or more than six years of ownership.

Referring momentarily to FIG. 3, dealers 201, 202, 203, 204, 205, 206 are in respective dealer areas 301, 302, 303, 304, 305, 306. Here, dealer areas 302, 303, 304, 305, 306 neighbor the dealer area 301. Although comparison dealers can be dealers that are in areas that neighbor the area of the interest dealer, in alternative embodiments, one or more comparison dealers is not in an area that neighbors the area of the interest dealer.

Continuing with Table 1, variable A is the number of vehicles that were sold by the interest dealer to customers residing in the interest dealer's area; variable B is the number of vehicles that were sold by a comparison dealer to customers residing in the interest dealer's area; variable C is the number of vehicles that were sold by the interest dealer to customers residing out of the interest dealer's area; and variable D is the number of vehicles that were sold by a comparison dealer to customers residing out of the interest dealer's area.

The cells of Table 1 represent two relationships between the interest dealer and a customer: a sales-based relationship and a geography-based relationship. By sorting the dealer service data 200 into categories, a finer, more granular measure of actual service retention r can be determined.

### Pairwise Dealer Comparison

Referring to Tables 2 and 3, certain cells Table 1 are shown for a first dealer 201 and a second dealer 202. Table 2 and Table 3 are tailored to the first dealer 201 and the second dealer 202 (e.g., as compared to Table 1, which focuses on an interest dealer and one or more comparison dealers).

In the tables, the variables are designated with subscripts i, j, respectively. The subscript i represents the dealer that is the interest dealer and the subscript j represents the dealer that is the comparison dealer. In Table 2, the first dealer 201 (represented by numeral 1) is the interest dealer (i=1) and the second dealer 202 (represented by numeral 2) is the comparison dealer (j=2).

TABLE 2
Table 1 for a first dealer (i = 1)

| | Sold by First Dealer | Sold by Second Dealer |
|---|---|---|
| First Dealer Area | | b_{1,2} |
| | | B_{1,2} |
| Second Dealer Area | c_{1,2} | |
| | C_{1,2} | |

Variable b_{1,2} is the number of vehicles that were sold by the second dealer 202 to customers residing in the first dealer's 201 area and that were serviced by the first dealer 201. Here, variable b_{1,2} does not include vehicles sold by other dealers (e.g., dealers 203, 204, 205, 206) to customers residing in the first dealer's 201 area and that were serviced by the first dealer 201. The same applies to variables c_{2,1}, b_{2,1}, c_{1,2}.

Variable c_{1,2} is the number of vehicles that were sold by the first dealer 201 to customers residing in the second dealer's 202 area and that were serviced by the first dealer 201.

Similarly, in Table 3, the second dealer 202 is the interest dealer (i=2) and the first dealer 201 is the comparison dealer (j=1).

TABLE 3
Table 1 for a Second Dealer (i = 2)

| | Sold by Second Dealer | Sold by First Dealer |
|---|---|---|
| Second Dealer Area | | b_{2,1} |
| | | B_{2,1} |
| First Dealer Area | c_{2,1} | |
| | C_{2,1} | |

Variable c_{2,1} is the number of vehicles that were sold by the second dealer 202 to customers residing in the first dealer's 201 area and that were serviced by the second dealer 202. Variable b_{2,1} is the number of vehicles that were sold by the first dealer 201 to customers residing in the second dealer's 202 area and that were serviced by the second dealer 202.

Some of the dealer service data 200 is found in both Table 2 and Table 3. For example, a vehicle that is sold by the second dealer 202 to a customer residing in the first dealer's 201 area is in the count for variable B_{1,2} for the first dealer 201 and is in the count for variable C_{2,1} for the second dealer 202.

Vehicles that show up in the dealer service data 200 for each of a pair of dealers are shared customers of the two dealers. These shared customers are sold by one dealer but, for example, are nearer another dealer. As such, the dealers are in competition for the shared customers.

The pair of dealers 201, 202 is evaluated using a pairwise comparison. Particularly, the shared customers of the two dealers 201, 202 are isolated and the actual service retention r of the two dealers 201, 202 on this population of shared customers is compared. The pairwise comparison using shared customers can be more accurate than comparing overall retention, particularly where these customers are more likely to be homogeneous.

In block 108, to calculate values for the pairwise comparison, values for variables b_{1,2}, b_{2,1}, c_{1,2}, c_{2,1} are determined from the dealer service data 200 and values for variables B_{1,2}, B_{2,1}, C_{1,2}, C_{2,1} are calculated based on the values for variables b_{1,2}, b_{2,1}, c_{1,2}, c_{2,1}. For each of the dealers 201, 202, the number of vehicles that were sold by the competing dealer to customers residing in the interest dealer's area (B_{1,2}, B_{2,1}) and the number of vehicles that were sold to customers residing out of the interest dealer's area (C_{1,2}, C_{2,1}) are calculated as follows:

B_{1,2}=C_{2,1}=b_{1,2}+c_{2,1}

B_{2,1}=C_{1,2}=b_{2,1}+c_{1,2}

In this example, the number of vehicles that were sold by the second dealer 202 to customers residing in the first dealer's 201 area (B_{1,2}) and the number of vehicles that were sold by the second dealer 202 to customers residing out of the second dealer's 202 area (C_{2,1}) are the same. Each is calculated as the number of vehicles that were sold by the second dealer 202 to customers residing in the first dealer's 201 area and that were serviced by the first dealer 201 (b_{1,2}) plus the number of vehicles that were sold by the second dealer 202 to customers residing out of the second dealer's 202 area and that were serviced by the second dealer 202 (c_{2,1}).

Similarly, the number of vehicles that were sold by the first dealer 201 to customers residing in the second dealer's 202 area (B_{2,1}) and the number of vehicles that were sold by the first dealer 201 to customers residing out of the first dealer's area (C_{1,2}) are the same. Each is calculated as the number of vehicles that were sold by the first dealer 201 to customers residing in the second dealer's 202 area and that were serviced by the second dealer 202 (b_{2,1}) plus the number of vehicles that were sold by the first dealer 201 to customers residing out of the first dealer's 201 area and that were serviced by the first dealer 201 (c_{1,2}).

More generally, the equations can be given as:

B_{i,j}=C_{j,i}=b_{i,j}+c_{j,i}

B_{j,i}=C_{i,j}=b_{j,i}+c_{i,j}

Here, the dealer numbers 1, 2 can be arbitrarily selected for subscripts i, j. One of subscripts i, j is selected to be 1 and the other of subscripts i, j is selected to be 2.

In block 110, the dealer service retention r^{b}, r^{c} (here, superscripts b, c represent categories represented by variables b, c) is calculated for each interest dealer (index i) relative to a comparison dealer (index j). As above, where the first dealer 201 is the interest dealer and the second dealer 202 is the comparison dealer, i=1, j=2; where the second dealer 202 is the interest dealer and the first dealer 201 is the comparison dealer, i=2, j=1). For each interest dealer i relative to a comparison dealer j, the retention r^{b}_{i,j}, r^{c}_{i,j} is calculated as follows:

$${r}_{i , j}^{b} = \frac{{b}_{i , j}}{{B}_{i , j}}$$

$${r}_{i , j}^{c} = \frac{{c}_{i , j}}{{c}_{i , j}}$$

Using the exemplary values of b_{1,2}=20, b_{2,1}=94, c_{1,2}=207, and c_{2,1}=117, exemplary values for service retention r are calculated for each dealer (as shown in Table 4). In block 112, an object (e.g., Table 4) is generated based on the values of service retention.

TABLE 4

| | | | Indexed | Saturday | |
|---|---|---|---|---|---|
| Dealer | Pairwise b/B | Pairwise c/C | Total | Hours | CSI |
| 1 | r^{b}_{1,2} = 19% | r^{c}_{1,2} = 70% | 89% | 0 | 88.1% |
| 2 | r^{b}_{2,1} = 30% | r^{c}_{1,2} = 81% | 111% | 5 | 91.9% |

The results of Table 4 show that the second dealer 202 has greater retention than the first dealer 201 in both category b/B (30% exceeds 19%) and category c/C (81% exceeds 70%). Second dealer 202 thus outperforms first dealer 201 in head-to-head competition on shared customers. Table 4 also includes other factors (e.g., controllable factors such as Saturday hours or the consumer satisfaction index (CSI)) that can help explain the difference in performance. As such, Table 4 is an object that provides feedback to the dealers 201, 202 to help them improve their dealer service retention r.

For a dealer with multiple bordering or interacting dealers, the dealer can be compared to each of its neighboring or interacting dealers individually, as described above in blocks 104, 106, 108, 110, 112, and in the aggregate, as described in further detail below.

Here, the dealer service data 200 is first sorted to be specific to each pair of dealers. For example, referring to FIG. 3, for the first dealer 201 (represented by numeral 1) that is bordered by the second dealer 202 (represented by numeral 2), a third dealer 203 (represented by numeral 3), a fourth dealer 204 (represented by numeral 4), a fifth dealer 205 (represented by numeral 5), and a sixth dealer 206 (represented by numeral 6), the dealer service data 200 is sorted to be specific to the pairs of dealers, each pair including the first dealer 201 as the interest dealer and one of the other dealers 202, 203, 204, 205, 206 as the comparison dealer.

As shown in Table 5, variables b_{1,2}, b_{2,1}, c_{2,1} are specific to the first dealer 201 and the second dealer 202; variables b_{1,3}, c_{1,3}, b_{3,1}, c_{3,1} are specific to the first dealer 201 and the third dealer 203; variables b_{1,4}, c_{1,4}, b_{4,1}, c_{4,1} are specific to the first dealer 201 and the fourth dealer 204; variables b_{1,5}, c_{1,5}, b_{5,1}, c_{5,1} are specific to the first dealer 201 and the fifth dealer 205; and variables b_{1,6}, c_{1,6}, b_{6,1}, c_{6,1} are specific to the first dealer 201 and the sixth dealer 206. A subscript a is used to indicate an aggregation of dealers (e.g., all comparison dealers, i.e., dealers 202, 203, 204, 205, and 206).

TABLE 5

| 1 and 2 | 1 and 3 | 1 and 4 | 1 and 5 | 1 and 6 | Aggregate |
|---|---|---|---|---|---|
| b_{2,1} = 90 | b_{3,1} = 38 | b_{4,1} = 63 | b_{5,1} = 56 | b_{6,1} = 24 | Σb_{i,1} = |
| | | | | | b_{a,1} = 271 |
| c_{1,2} = 390 | c_{1,3} = 197 | c_{1,4} = 267 | c_{1,5} = 202 | c_{1,6} = 131 | Σc_{1,j} = |
| | | | | | c_{1,a} = 1187 |
| c_{2,1} = 404 | c_{3,1} = 390 | c_{4,1} = 472 | c_{5,1} = 268 | c_{6,1} = 73 | Σc_{i,1} = |
| | | | | | c_{a,1} = 1607 |
| b_{1,2} = | b_{1,3} = 47 | b_{1,4} = 198 | b_{1,5} = 88 | b_{1,6} = 113 | Σb_{1,j} = |
| 101 | | | | | b_{1,a} = 547 |

The data for each pair of dealers is used to calculate dealer service retention r to compare each pair of dealers in each of categories represented by b/B and c/C as shown in Table 6 based on the example values of Table 5. The first dealer 201 outperforms all neighboring dealers, as observed by comparing r^{b}_{1,j} to r^{b}_{j,1}, and r^{c}_{1,j} to r^{c}_{j,1} for all neighboring dealers j, and noting that dealer 201's value exceeds (i.e., outperforms) that of each neighboring dealer on both comparisons, except the third dealer 203 in both categories b/B and c/C. Another way to measure performance is to compare the overall retention of shared customers by comparing (r^{b}_{1,j}+r^{c}_{1,j}) to (r^{b}_{j,1}+r^{c}_{j,1}) for all neighboring dealers j. In this method, dealer 201 outperforms all neighboring dealers j except dealer 203.

TABLE 6

| 1 and 2 | 1 and 3 | 1 and 4 | 1 and 5 | 1 and 6 | Aggregate |
|---|---|---|---|---|---|
| r^{b}_{1,2} = 20% | r^{b}_{1,3} = 11% | r^{b}_{1,4} = 30% | r^{b}_{1,5} = 25% | r^{b}_{1,6} = 61% | r^{b}_{1,a} = 25% |
| r^{b}_{2,1} = 19% | r^{b}_{3,1} = 16% | r^{b}_{4,1} = 19% | r^{b}_{5,1} = 22% | r^{b}_{6,1} = 15% | r^{b}_{a,1} = 19% |
| r^{c}_{1,2} = 18% | r^{c}_{1,3} = 84% | r^{c}_{1,4} = 81% | r^{c}_{1,5} = 78% | r^{c}_{1,6} = 85% | r^{c}_{1,a} = 81% |
| r^{c}_{2,1} = 80% | r^{c}_{3,1} = 89% | r^{c}_{4,1} = 70% | r^{c}_{5,1} = 75% | r^{c}_{6,1} = 39% | r^{c}_{a,1} = 75% |

Additionally, the data tailored to each pair of dealers can be aggregated and the first dealer 201 can be compared to the aggregate of the dealers 202, 203, 204, 205, 206. The right-hand column of Table 5 shows the aggregated data from the other columns and the right-hand column of Table 6 shows the dealer service retention r calculated using the aggregated data. The dealer service retention r is calculated using aggregated data as follows:

$${B}_{1 , a} = {C}_{a , 1} = {b}_{1 , a} + {c}_{a , 1} = {\sum }_{j = 2}^{j = 6} {b}_{1 , j} + {\sum }_{i = 2}^{i = 6} {c}_{i , 1}$$

$${B}_{a , 1} = {C}_{1 , a} = {b}_{a , 1} + {c}_{1 , a} = {\sum }_{i = 2}^{i = 6} {b}_{i , 1} + {\sum }_{j = 2}^{j = 6} {c}_{1 , j}$$

$${r}_{1 , a}^{b} = \frac{{b}_{1 , a}}{{B}_{1 , a}}$$

$${r}_{a , 1}^{b} = \frac{{b}_{a , 1}}{{B}_{a , 1}}$$

$${r}_{1 , a}^{c} = \frac{{c}_{1 , a}}{{C}_{1 , a}}$$

$${r}_{a , 1}^{c} = \frac{{c}_{a , 1}}{{C}_{a , 1}}$$

In this example, the first dealer 201 outperforms the aggregate of the neighboring comparison dealers 202, 203, 204, 205, 206.

Various embodiments of the present disclosure are disclosed herein. The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A method, comprising:
calculating, by a system comprising a processor, for a first pair of dealers including a first dealer and a second dealer:
a first number of vehicles sold by the second dealer to customers residing in a first-dealer area, associated with the first dealer, and serviced by the first dealer;
a second number of vehicles sold by the second dealer to customers residing in the first-dealer area and serviced by the second dealer;
a third number of vehicles sold by the first dealer to customers residing in a second-dealer area, associated with the second dealer, and serviced by the second dealer;
a fourth number of vehicles sold by the first dealer to customers residing in the second-dealer area and serviced by the first dealer;
a first value of service retention for the first dealer in a first category as the first number of vehicles divided by a first sum of the first number of vehicles and the second number of vehicles;
a second value of service retention for the second dealer in a second category as the second number of vehicles divided by a second sum of the first number of vehicle and the second number of vehicles;
a third value of service retention for the second dealer in the first category as the third number of vehicles divided by a third sum of the third number of vehicles and the fourth number of vehicles; and
a fourth value of service retention for the first dealer in the second category as the fourth number of vehicles divided by a sum of the third number of vehicle and the fourth number of vehicles; and
generating, by a system, a first object comprising a comparison of one or both of:
the first value of service retention and the third value of service retention; and
the second value of service retention and the fourth value of service retention.

2. The method of claim 1, further comprising generating, by the system, the first object comprising a value of a controllable factor for each of the first dealer and the second dealer.

3. The method of claim 1, further comprising generating, by the system, the first object comprising a comparison of each of:
the first value of service retention and the third value of service retention; and
the second value of service retention and the fourth value of service retention.

4. The method of claim 1, wherein the first-dealer area and the second-dealer area are directly adjacent to one another.

5. The method of claim 1, further comprising accessing first service records from a first database, associated with the first dealer, and second service records from a second database, associated with the second dealer.

6. The method of claim 1, further comprising accessing first sales records from a first database, associated with the first dealer, and second sales records from a second database, associated with the second dealer.

7. The method of claim 1, further comprising calculating, by the system, for a second pair of dealers including the first dealer and a third dealer:
a fifth number of vehicles sold by the third dealer to customers residing in the first-dealer area and serviced by the first dealer;
a sixth number of vehicles sold by the third dealer to customers residing in the first-dealer area and serviced by the third dealer;
a seventh number of vehicles sold by the first dealer to customers residing in a third-dealer area, associated with the third dealer, and serviced by the third dealer; and
an eighth number of vehicles that were sold by the first dealer to customers residing in the third-dealer area, and serviced by the first dealer.

8. The method of claim 7, further comprising calculating, by the system, for the second pair of dealers including the first dealer and the third dealer:
a fifth value of service retention for the first dealer in the first category as the fifth number of vehicles divided by a fifth sum of the fifth number of vehicles and the sixth number of vehicles;
a sixth value of service retention for the second dealer in the second category as the sixth number of vehicles divided by a sixth sum of the fifth number of vehicles and the sixth number of vehicles;
a seventh value of service retention for the second dealer in the first category as the seventh number of vehicles divided by a seventh sum of the seventh number of vehicles and the eighth number of vehicles; and
an eighth value of service retention for the first dealer in the second category as the eighth number of vehicles divided by an eighth sum of the seventh number of vehicle and the eighth number of vehicles.

9. The method of claim 8, further comprising generating, by a system, the first object comprising a comparison of one or both of:
the fifth value of service retention and the seventh value of service retention; and
the sixth value of service retention and the eighth value of service retention.

10. The method of claim 7, further comprising calculating, by a system:
a first aggregated number of vehicles sold by a dealer other than the first dealer to customers residing in the first-dealer area and serviced by the first dealer, the first aggregated number including the first number of vehicles and the fifth number of vehicles;
a second aggregated number of vehicles sold by a dealer other than the first dealer to customers residing in the first-dealer area and serviced by a dealer other than the first dealer, the second aggregated number including the second number of vehicles and the sixth number of vehicles;
a third aggregated number of vehicles sold by the first dealer to customers residing a dealer other than the first-dealer area and serviced by a dealer other than the first dealer, the third aggregated number including the third number of vehicles and the seventh number of vehicles; and
a fourth aggregated number of vehicles sold by the first dealer to customers residing in a dealer area other than the first-dealer area and serviced by the first dealer, the fourth aggregated number including the fourth number of vehicles and the eighth number of vehicles.

11. The method of claim 10, further comprising calculating, by a system:
a fifth value of service retention for the first dealer in the first category as the first aggregated number of vehicles divided by a fifth sum of the first aggregated number of vehicles and the second aggregated number of vehicles;
a sixth value of service retention for dealers other than the first dealer in the second category as the second aggregated number of vehicles divided by a sixth sum of the first aggregated number of vehicles and the second aggregated number of vehicles;
a seventh value of service retention for dealers other than the first dealer in the first category as the third aggregated number of vehicles divided by a seventh sum of the third aggregated number of vehicles and the fourth aggregated number of vehicles; and
an eighth value of service retention for the first dealer in the second category as the fourth aggregated number of vehicles divided by an eighth sum of the third aggregated number of vehicle and the fourth aggregated number of vehicles.

12. The method of claim 11, further comprising generating, by a system, the first object comprising a comparison of one or both of:
the fifth value of service retention and the seventh value of service retention; and
the sixth value of service retention and the eighth value of service retention.

13. A system, comprising:
a processor;
a computer-readable medium comprising computer-executable instructions that, when executed by the processor, cause the processor to perform operations comprising:
calculating, for a first pair of dealers including a first dealer and a second dealer:
a first number of vehicles sold by the second dealer to customers residing in a first-dealer area, associated with the first dealer, and serviced by the first dealer;
a second number of vehicles sold by the second dealer to customers residing in the first-dealer area and serviced by the second dealer;
a third number of vehicles sold by the first dealer to customers residing in a second-dealer area, associated with the second dealer, and serviced by the second dealer;
a fourth number of vehicles sold by the first dealer to customers residing in the second-dealer area and serviced by the first dealer;
a first value of service retention for the first dealer in a first category as the first number of vehicles divided by a first sum of the first number of vehicles and the second number of vehicles;
a second value of service retention for the second dealer in a second category as the second number of vehicles divided by a second sum of the first number of vehicle and the second number of vehicles;
a third value of service retention for the second dealer in the first category as the third number of vehicles divided by a third sum of the third number of vehicles and the fourth number of vehicles; and
a fourth value of service retention for the first dealer in the second category as the fourth number of vehicles divided by a fourth sum of the third number of vehicle and the fourth number of vehicles; and
generating a first object comprising a comparison of one or both of:
the first value of service retention and the third value of service retention; and
the second value of service retention and the fourth value of service retention.

14. The system of claim 13, the operations further comprising generating the first object comprising a value of a controllable factor for each of the first dealer and the second dealer.

15. The system of claim 13, the operations further comprising generating the first object comprising a comparison of each of:
the first value of service retention and the third value of service retention; and
the second value of service retention and the fourth value of service retention.

16. The system of claim 13, wherein the first-dealer area and the second-dealer area are directly adjacent to one another.

17. The system of claim 13, the operations further comprising accessing first service records from a first database, associated with the first dealer, and second service records from a second database, associated with the second dealer.

18. The system of claim 13, the operations further comprising accessing first sales records from a first database, associated with the first dealer, and second sales records from a second database, associated with the second dealer.

19. A computer-readable storage device comprising computer-executable instructions that, when executed by a processor, cause the processor to perform operations comprising:
calculating, for a first pair of dealers including a first dealer and a second dealer:
a first number of vehicles sold by the second dealer to customers residing in a first-dealer area, associated with the first dealer, and serviced by the first dealer;
a second number of vehicles sold by the second dealer to customers residing in the first-dealer area and serviced by the second dealer;
a third number of vehicles sold by the first dealer to customers residing in second-dealer area, associated with the second dealer, and serviced by the second dealer;
a fourth number of vehicles sold by the first dealer to customers residing in the second-dealer area and serviced by the first dealer;
a first value of service retention for the first dealer in a first category as the first number of vehicles divided by a first sum of the first number of vehicles and the second number of vehicles;
a second value of service retention for the second dealer in a second category as the second number of vehicles divided by a second sum of the first number of vehicle and the second number of vehicles;
a third value of service retention for the second dealer in the first category as the third number of vehicles divided by a third sum of the third number of vehicles and the fourth number of vehicles; and
a fourth value of service retention for the first dealer in the second category as the fourth number of vehicles divided by a fourth sum of the third number of vehicle and the fourth number of vehicles; and
generating a first object comprising a comparison of one or both of:
the first value of service retention and the third value of service retention; and
the second value of service retention and the fourth value of service retention.

20. The computer readable storage device of claim 19, the operations further comprising generating the first object comprising a value of a controllable factor for each of the first dealer and the second dealer.
